(19) United States
(12) Patent Application Publication
(10) Pub. No.: US 2008/0066597 A1
(43) Pub. Date: Mar. 20, 2008

(54) ROTARY DIE CUTTER

(75) Inventor: Ramon SERRA OBIOL, Barcelona (ES)

Correspondence Address: EGBERT LAW OFFICES, 412 MAIN STREET, 7TH FLOOR, HOUSTON, TX, 77002, US

(73) Assignee: CIMCO, S.L., Martorell (ES)

(21) Appl. No.: 11/869,323

(22) Filed: Oct. 9, 2007

Related U.S. Application Data
(63) Continuation-in-part of application No. 10/535,807, filed on Dec. 12, 2005, now abandoned.

(30) Foreign Application Priority Data
Nov. 28, 2002 (ES) P 200202736

(51) Int. Cl. B23D 25/12

(52) U.S. Cl. 83/343; 83/346

(57) ABSTRACT

The rotary die cutter includes a frame, having rails and vertical post walls, and a cylinder supported by the vertical post walls at a first position. There is a polyurethane tube affixed to and extended over the cylinder. First and second rings are affixed to the ends of the cylinder for fixing a position of the polyurethane tube. A pair of bearing holders at each end of the cylinder vertically lift the cylinder from a first position to a second position. The bearing holders are engaged to lifting screws driven by a motor. A pair of sliding plates at each end of the cylinder axially or horizontally shift the cylinder when lifted from the first position to a second position. The sliding plates are engaged to a screw driven by a motor for horizontal movement. The cylinder is rotated by a pulley assembly attached to the bearing holders.

### CROSS-REFERENCE TO RELATED APPLICATIONS

The present application is a continuation-in-part of U.S. patent application Ser. No. 10/535,807, filed on Dec. 12, 2005, and entitled “Rotary Die Cutter”, presently pending.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to rotary die cutters.

2. Description of Related Art Including Information Disclosed Under 37 CFR 1.97 and 37 CFR 1.98.

Machines are often used for the rotary die cutting of laminate material, such as corrugated cardboard. These rotary die cutting machines are made up of two rollers. One of the rollers holds the die and works against the other roller. The other roller is generally manufactured out of steel or coated in polyurethane. When work is performed against the polyurethane material, the steel threads of the die penetrate the polyurethane surface for about one or two millimeters. As a result, a very irregular wear occurs against the polyurethane surface.

In those dies that are used for the manufacturing of corrugated cardboard boxes, blades are used for the cutting of the sheet. Additionally, rounded blades are utilized for the creasing of the sheets during the manufacture of the corrugated cardboard box. The result of irregular wear of polyurethane will serve to produce false creases when the rounded blade strike areas deteriorated by the blades.

As a result, in the prior art, there is a lack of uniformity in the wear of the polyurethane surface. The result of this wear produces poor die cutting operations. These poor die cutting operations occur both in the cutting of the sheets and in the creasing of the sheets. As a result, the lack in the uniformity of the polyurethane wear will produce a decrease in the quality of the product produced from the die cutting operation.

One of the solutions to this problem of polyurethane wear is to provide polyurethane cylinders with an axial shifting that ranges between plus or minus 20 millimeters. This serves to prevent the circumferential blades from always hitting the same spot or location of the polyurethane surface. Another attempted solution to this problem includes turning or rectifying the very surfaces by means of a cutting tool. As a result, the diameter of the cylinder is reduced in the affected areas and the unaffected areas. As a result, the useful life of the polyurethane surface is reduced. Additionally, frequent rotation of the polyurethane surface is also utilized in the prior art. By way of this frequent rotation of the polyurethane, it is necessary to separate the polyurethane from the surface of the cylinder. This is accomplished by removing a ring from one of the ends of the cylinder so as to shift the remainder of the rings and assemble it on the other end. This process is repeated until reaching a useful life of the polyurethane surface due to the wear and loss of thickness.

The polyurethane surface is typically a thin tube of approximately 200 millimeters in thickness which covers the cylinder. These polyurethane tubes are held by pressure in runners incorporated on the cylinders. Levers and mallets are utilized to remove these polyurethane tubes. As such, it is rather complicated process to remove the polyurethane tube from the cylinder.

Importantly, it should be noted that uniform wear in the polyurethane surfaces is not achieved with these prior art processes. Whenever a circular blade strikes on a polyurethane surface, it produces a groove thereon. During axially shifting, this groove becomes a band. With the rotation of the bands, all of the parts end up with equal wear in a similar area.

It is an object of the present invention to provide a solution to the aforestated problems.

These and other objects and advantages of the present invention will become apparent from a reading of the attached specification and appended claims.

### BRIEF SUMMARY OF THE INVENTION

A rotary die cutter apparatus for working on cardboard sheets comprises a frame, a cylinder supported, a polyurethane tube affixed to the cylinder and extending thereover, a first ring affixed to the cylinder and extending therearound at one end of the polyurethane tube, a second ring affixed to the cylinder and extending therearound at an opposite end of the polyurethane tube, a pair of bearing holders rotatably supporting the cylinder at opposite ends of the cylinder, a rubber-coated pulley affixed to one of the ends of the cylinder, a cogged drive belt cooperatively mounted over the pulley such that a movement of the drive belt causes a corresponding rotation of the pulley and the cylinder, and a first motor having a shaft drivedly connected thereto. The invention also includes a pair of lifting screws extending transversely to the cylinder, a pair of gearboxes cooperative with the pair of lifting screws, a second motor having a shaft extending therefrom and cooperative with the pair of lifting screws through the pair of gearboxes such that the pair of lifting screws operates so as to raise or lower the cylinder. The invention further includes a bedplate, a pair of sliding plates being mounted to the bedplate and having the pair of gearboxes respectively affixed thereto and supported on slide rails by linear bearings, and a third motor coupled by a screw into the pair of sliding plates for shifting the cylinder. The frame includes a die holding cylinder positioned in proximity to an exterior of the polyurethane tube. The first and second rings serve to fix a position of the polyurethane tube on the cylinder. The cogged drive belt is cooperatively mounted over the pulley such that the movement of the drive belt causes a corresponding rotation of the pulley and the cylinder when engaged. The first motor serves to rotate the cylinder at a desired rate. The cylinder is horizontally translatable relative to the die holding cylinder. The cylinder has a length that is greater than a length of the die holding cylinder. The polyurethane tube has a hardness of between 90° to 95° Shore.

The present invention serves to prevent defective die cutting at the seams of the polyurethane rings and to reduce the manufacturing cost. Removing, shifting and assembling of the polyurethane tube is substantially simple. There is no need for using mallets or levers.

### BRIEF DESCRIPTION OF THE SEVERAL VIEWS OF THE DRAWINGS

FIG. 1 is a sectional view of the rotary die cutter apparatus of the present invention showing the cylinder in one position relative to the die holding cylinder.

FIG. 2 is a side elevation view of the rotary die cutter apparatus of the present invention showing the frame and the cylinder in another position relative to the to the die holding cylinder.

FIG. 3 is a cross-sectional view of the rotary die cutter apparatus of the present invention showing the operation of the motor engaged to the lift screws.

FIG. 4 is another cross-sectional view of the rotary die cutter apparatus of the present invention showing a lifted positioned of the cylinder.

FIG. 5 is a partial perspective view of an illustration of an end of the rotary die cutter apparatus of the present invention.

### DETAILED DESCRIPTION OF THE INVENTION

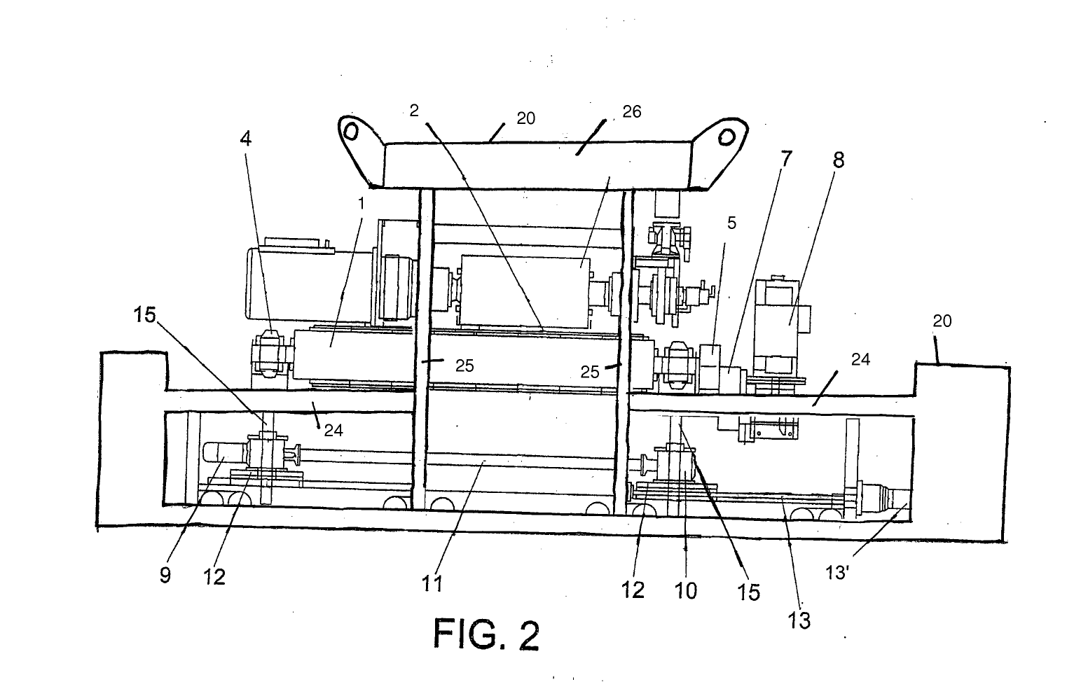

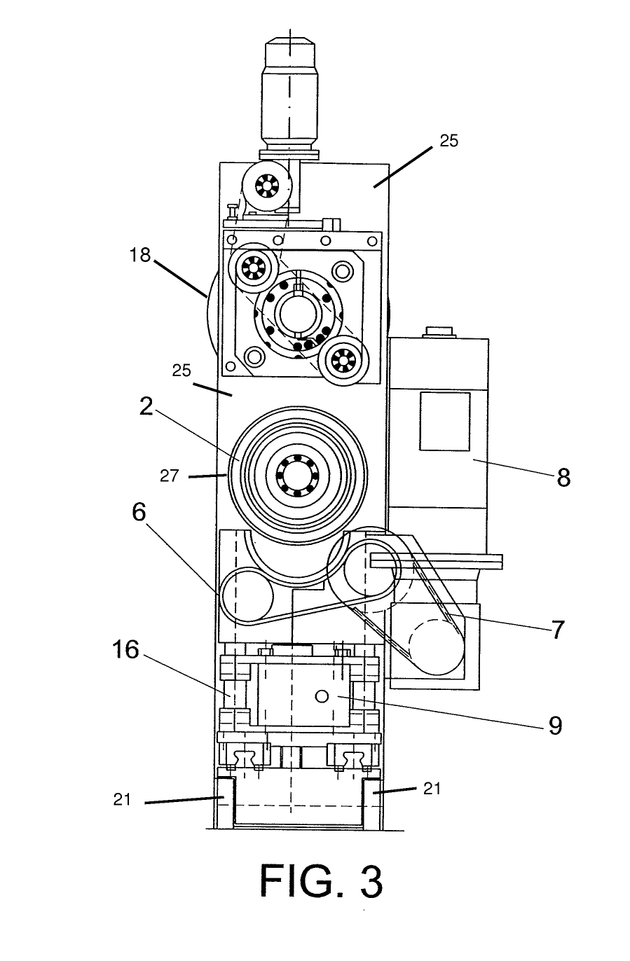

The rotary die cutter apparatus of the present invention has a frame 20 on which a cylinder 1 is supported. The frame 20 houses all elements of the present invention. As shown in FIG. 2, the frame 20 has rails 24 and vertical post walls 25. A top ledge 26 is supported above the vertical post walls 25. There are other stationary and mounted structures, including the dye cylinder 18 and slide rails 21. The dye cylinder 18 has a corresponding motor 22 and at least one cog belt 23 to rotate the dye cylinder 18. The slide rails 21 are mounted along a bedplate 17 at the bottom of the frame 20, as shown in FIG. 3.

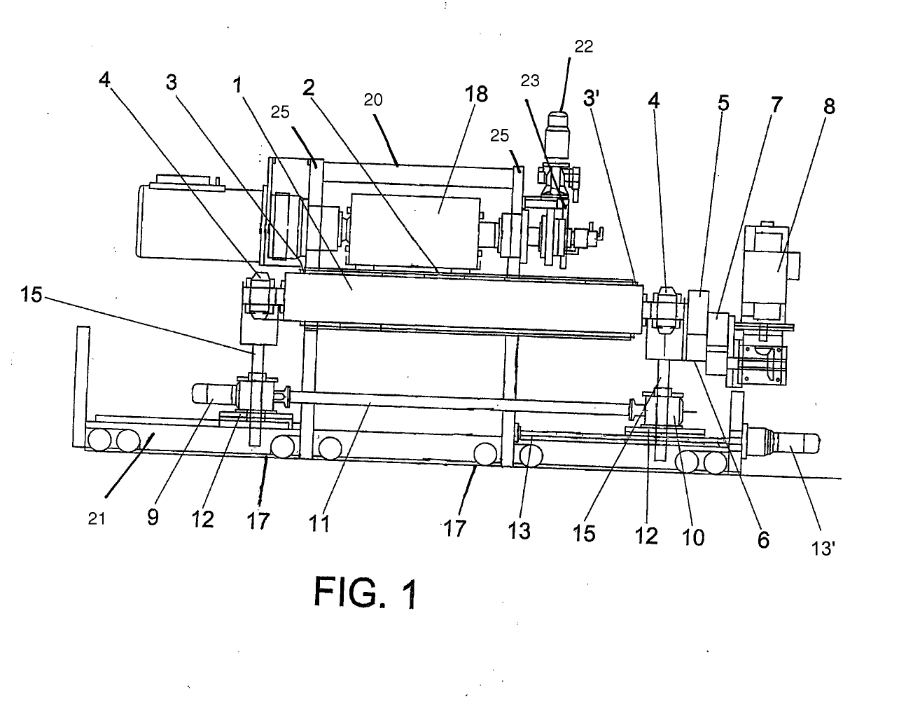

The cylinder 1 of the present invention is movably positioned within the frame 20 along a length of the cylinder 1 as shown in FIG. 1. The cylinder 1 has a polyurethane tube 2 extending thereover. Rings 3 and 3′ are located at opposite ends of the polyurethane tube 2 so as to fix the position of the polyurethane tube 2. At rest, the cylinder 1 is stationary in the frame 20. The cylinder 1 rests upon holes 27 in the vertical post walls 25.

When rotating, there are bearing holders 4 are located at opposite ends of the cylinder so as to rotatably support the cylinder 1. The cylinder 1 is no longer supported by the vertical post walls 25 because the bearing holders 4 engage the ends of the cylinder 1. As previously discuss the amount of distance of lift is about 20mm only. Then, a rubber-coated pulley 5 is axially affixed to the cylinder and provides a surface whereby a cogged belt 6 extends thereover. The cogged belt 6 cooperates with the pulley 5 so as to facilitate the rotation of the cylinder 1. A variable speed motor 8 has a shaft electrically cooperative with cylinder 1 in a desired manner. The variable speed motor 8 is connected by another cogged belt 7 to the pulley 5 in order to rotate the cylinder 1.

The die holding cylinder 18 is positioned above the cylinder 1. Variable speed motor 8 can be adjusted to be cooperative with the motor 22 of the dye cylinder 18. In the manner, the laminate can be cut in a particular rate and pattern according the respective rotations of the cylinder 1 and dye cylinder 22. The top ledge 26 is positioned above the dye holding cylinder 18.

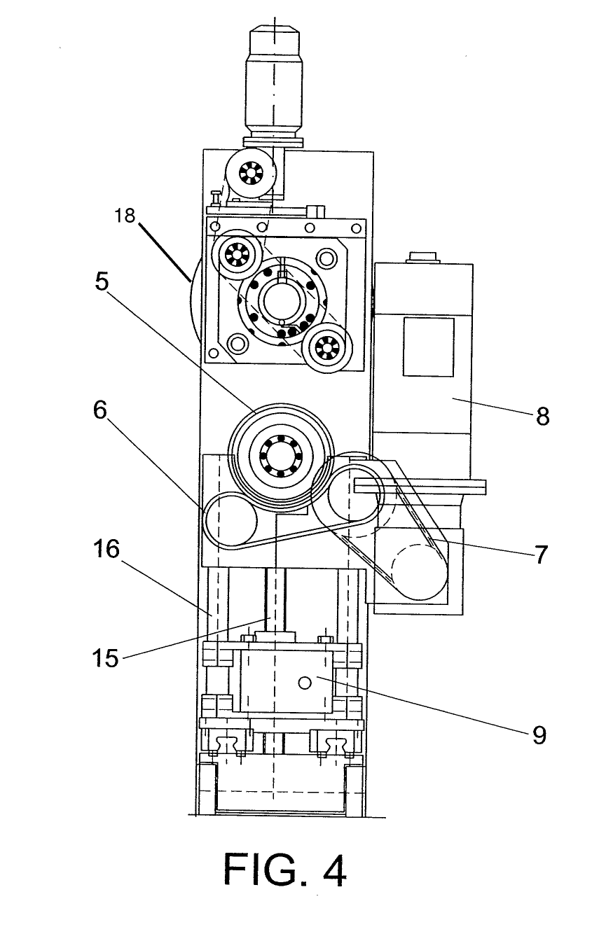

When the cylinder 1 is rotated by the variable speed motor 8, the cylinder 1 is lifted to engage the surface fo the dye holding cylinder 18. As such, the die cutter apparatus of the present invention also has a motor 9 and a shaft 11 that is cooperative with lifting screws 15. Lifting screws 15 act on the bearing holders 4 to engage ends of the cylinder 1, raising the cylinder 1 into position, where the cogged belt 6 initiates rotations by the polyurethane tube 2. FIGS. 3 and 4 show movement of the cogged belt 6 and cogged belt 7, while the cylinder 1 remains a first position at rest on the vertical post walls 25 (FIG. 3) and while the cylinder 1 shifts a distance for rotation supported by the bearing holders 4 (FIG. 4). The cogged belt 6 is not shown to support the cylinder 1 at all times. Gear boxes 10 are cooperative with the respective lifting screws 15, converting rotational movement into vertical displacement along the threaded lift screw 15. The operation of the motor 9 and the rotation of the shaft 11 will serve to cause a coordinated rotation of the lifting screws 15 so as to lift and lower the cylinder 1.

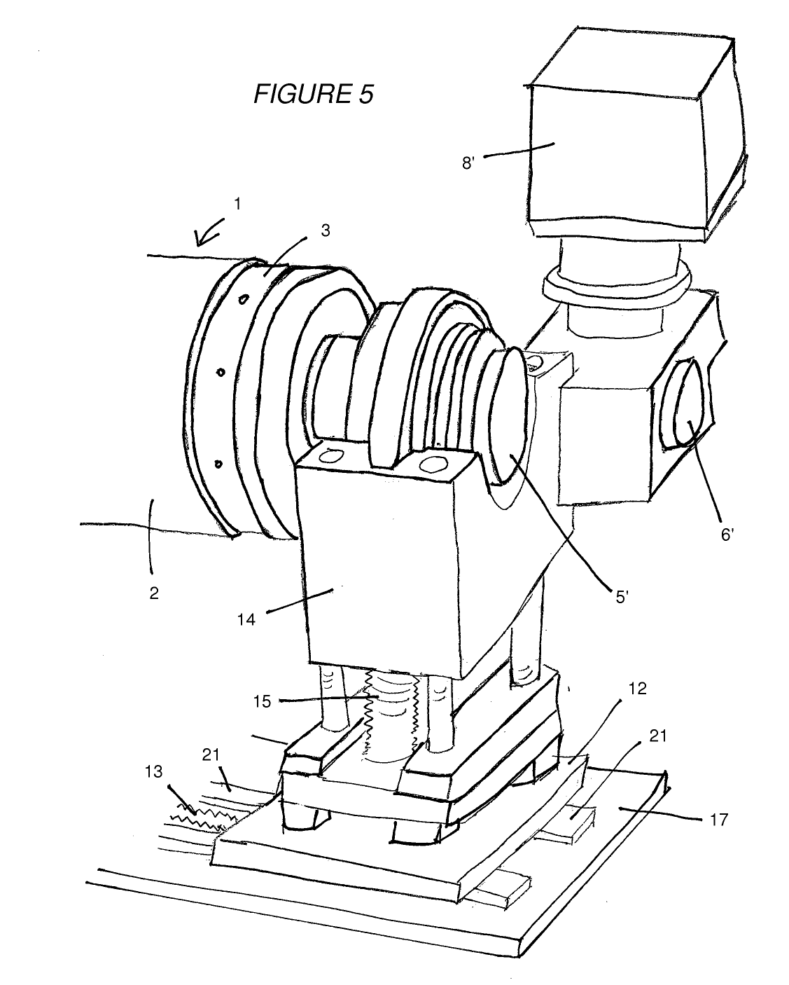

FIG. 5 shows a partial perspective illustration of an end of the rotary die cutter apparatus of the present invention. The bearing holder 14 is shown without the pulley 5, cogged belt 6, and cogged belt 7. The attachment 5′ for the pulley and the attachment 6′ for the cogged belt are shown in their relative positions in FIG. 5. Motor 8′ is an illustration of possible placement for engaging the cogged belts and pulley for rotating the cylinder 1. Additionally, FIG. 5 shows a lift screw 15 on the slide plate 12. The slide plate 12 is horizontally shift along the axis of the cylinder 1 by the screw 13 between the slide rails 21. As such, the three dimensions of movement and control of the cylinder 1 are shown in this schematic illustration.

A pair of sliding plates 12 are supported on guides with linear bearings. A screw 13 associated with an alternating current motor 13′ allows for the longitudinal shifting of the polyurethane cylinder 1 along the axis of the cylinder 1. This shifting movement occurs in a horizontal orientation. The lifting and sliding mechanism are movably mounted on the bedplate 17, as shown in FIG. 1. The alternating current motor 13′ and screw 13 remain in place relative to the bedplate 17 and frame 20, as the cylinder 1 moves along slide rails 21 on the sliding plates 12. The shaft 11 and the cylinder 1 engage a respective bearing holder 4 and sliding plate 12 at ends opposite the motor 13′ so that the cylinder 1 and connected structures move horizontally together. As such, the cylinder 1 can be rotating by motor 8, while moving horizontally by the alternating current motor 13′. In this manner, the path of the cuts by the dye holding cylinder 18 can be made variable on the polyurethane tube 2 around the cylinder 1.

In the present invention, the cylinder 1 will rotate and shift in a controlled and very slow manner. This pattern will be in accordance with a forward movement preselected by the operator and the desired rotating speed of the machine. The shifting of the cylinder 1 is performed on the slide rails 21 with linear bearings by means of the screw 13 operated by the alternating current motor 13′. Speed variations can occur, as desired. When the cylinder 1 has shifted along its entire run, the apparatus of the present invention can emit a warning signal so as to allow the operator to decide whether to stop the machine and rotate the polyurethane tube 2 or reverse the shift direction of the cylinder 1 to an appropriate position.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A rotary die cutter apparatus for working on cardboard sheets comprising:
a frame having a plurality of rails and a plurality of vertical post walls;
a cylinder supported by said vertical post walls at a first position;
a polyurethane tube affixed to said cylinder and extending thereover;
a first ring affixed to said cylinder and extending therearound at one end of said polyurethane tube;
a second ring affixed to said cylinder and extending therearound at an opposite end of said polyurethane tube, said first and second rings for fixing a position of said polyurethane tube on said cylinder;
a pair of bearing holders rotatably supporting said cylinder at opposite ends of said cylinder at a second position;
a rubber-coated pulley affixed to one end of said cylinder at said second position;
a cogged device belt cooperatively mounted over said pulley such that a movement of said drive belt causes a corresponding rotation of said pulley and said cylinder at said second position;
a first motor means having a shaft drivingly connected thereto, said shaft having a belt extending to said pulley, said first motor means for rotating said cylinder at said second position;
a pair of lifting screws extending transversely from said bearing holders;
a pair of gearboxes cooperative respectively with said pair of lifting screws;
a second motor means having a shaft extending therefrom and cooperative with said pair of lifting screws through said pair of gearboxes, said second motor means for operating said pair of lifting screws so as to raise or lower said bearing holders, said cylinder being rotatably supported from said first position to said second position by said bearing holders lifted by said lifting screws;
a pair of sliding plates having said pair of gearboxes respectively affixed thereonto, said pair of sliding plates supported on slide rails on a bedplate at a bottom of said frame and supported by linear bearings;
a third motor means coupled by a screw to said pair of sliding plates, said sliding plates engaged respectively to said pair of lifting screws and said pair of bearing holders, said third motor means horizontally shifting said cylinder when said cylinder is rotatably supported by said bearing holders from said first position to said second position; and
a die holding cylinder engaging a respective cog belt and motor for rotational movement, said die holding cylinder being mounted in said frame and positioned in proximity to an exterior of said polyurethane tube, said cylinder being axially translated and vertically shifted relative to said die holding cylinder.

2. The apparatus of claim 1, said cylinder having a length that is greater than a length of said die holding cylinder.

3. The apparatus of claim 1, said polyurethane tube having a hardness of 900 to 95° Shore.
